(19) United States
(12) Patent Application Publication
(10) Pub. No.: US 2025/0201141 A1
(43) Pub. Date: Jun. 19, 2025

(54) ARTIFICIAL INTELLIGENCE-BASED SYSTEMS AND METHODS FOR TRAINING AND EDUCATION

(71) Applicant: Hemant Kumar SETYA, Tokyo (JP)

(72) Inventor: Hemant Kumar SETYA, Tokyo (JP)

(21) Appl. No.: 18/981,563

(22) Filed: Dec. 15, 2024

(30) Foreign Application Priority Data
Dec. 14, 2023 (IN) 202311085499

(51) Int. Cl. G09B 7/00; G06F 16/435; G06F 16/438

(52) U.S. Cl. CPC G09B 7/00; G06F 16/435; G06F 16/438

(57) ABSTRACT

The computer-implemented system (100) for training and education involves user devices (102-n) gathering inputs from users and a server (108) receiving these inputs through a communication network (106). The server (108) includes a memory (204) and a processor (202) running instructions from this memory (204). A query processing and scripting module (210) uses artificial intelligence to generate a draft script from information retrieved from databases (110). The compliance check module (216), verifies the draft script against predefined parameters, generating structured data from the compliant script. An audio/video search engine (212) utilizes artificial intelligence to generate diverse audio/video content based on structured data. A review module (214) evaluates this content's relevance, creating concise audio/video segments (“nuggets”) from the pertinent material and filtering out irrelevant content. This linked and relevant content is displayed on user devices for effective and personalized learning and training purposes.

### FIELD OF THE INVENTION

The present invention relates to training and education platforms and in particular relates to an artificial intelligence-based system and method to facilitate content creation and process for training and education of, for example, healthcare industry professionals.

### BACKGROUND OF THE INVENTION

Decisions regarding training and education involve numerous factors, encompassing the characteristics of trainers and trainees, educational levels, personal beliefs, perceptions, behaviors, and the standards and guidelines governing their educational pathways. Additionally, guidelines set by education and training systems and players contribute to the complexity of decisions related to content selection. The consideration of these multiple parameters renders the decision-making process exceedingly complex. This multidimensional requirement is further compounded by challenges such as the laborious process of searching for content, filtering relevant material, and the associated costs, especially in high-skilled fields such medical profession.

Further, the training of professionals, for example, in the healthcare field, encounter persistent challenges, including skill mismatches between the Healthcare Professionals and the conveyer of the critical information, due to insufficient awareness and knowledge of either party, lack of periodic skilling, unavailability of personalized competency training, leading to high rates of burnout and attrition, as well as inefficiencies, excessive costs, and redundancies. Consequently, there is a loss of revenue generation.

With the continuous rise in the adoption of digital marketing strategies, pharmaceutical brands have access to enormous amounts of data that they can use with artificial intelligence (AI) to build the engagement of/with healthcare professionals (HCPs). AI can help boost the engagement of HCPs through personalization using machine learning, natural language processing (NLP), and deep learning to analyze both HCPs' and customer data. AI can also help in drawing insights to create more accurate segments of targeted HCPs and can help create cluster groups based on specific characteristics, through which one can, for example, personalize communication. Then there is an opportunity to use predictive modeling to analyze the behavior of the target audiences in different verticals. Further, one can employ chatbots that can also help boost engagement-however, it is restricted to NLP at present.

Further, HCPs need continuous training and education to stay updated with the latest advancements in the field. While providing education is essential, conducting face-to-face interactions with HCPs is still tedious and inefficient. Further, the training will mostly depend on the patient cohort of the HCPs. Though AI may also help in creating high-quality training videos, the level of engagement needs to be continuously high and the relevancy up to the mark.

Healthcare organizations spend a lot of money on various unproductive engagements and human-based customer engagement professionals, which eventually adds to the cost. Efforts have been made in the past to provide a solution to some of the stated problems above. WO2019207456 A1 discloses a system for detailing products and services of a life science company through a bot form of sales force personnel along with slide content to a plurality of healthcare professionals (HCPs). The system comprises a plurality of computing devices, an authoring module, an information module, an HCP behavior processing module, a campaign module, an interactive communication module, and a communication network. Despite providing product and service information to healthcare customers in a cost-efficient way through such tools, the level of engagement with both the healthcare service providers and the customers is still not up to the mark due to the complexity and the exponentially growing volume of the content that is being available to the users.

These technologies though highly useful are still in their nascent stage in terms of the content these systems can provide and its consumption by the end-user based on how relevant or engaging it is. Therefore, there is a pressing need to develop an AI-based system and method that streamlines and automates the content creation and ensures process compliance, memory retention, and quality in training and education.

### OBJECT OF THE INVENTION

The present invention aims to address the aforementioned issues of conventional computer-assisted training and educational platforms for novices and professionals in a given sector by bridging skill gaps, reducing attrition rates, cutting costs, and enhancing overall efficiency, thereby empowering them and creating opportunities for growth while fostering dynamic learning and personalized experiences.

An objective of the present invention is to provide a system and method that facilitates, streamlines, and automates the content creation and ensures process compliance, memory retention, and quality in training and education for market professionals in the industry.

Another objective is to use AI to curate content, leverage feedback, make data-driven recommendations to personalize pharma/wholesaler/distributor engagements with healthcare professionals, and promote an improved continuous learning journey.

Yet another objective of the present invention is to attain a high-affinity score, a high net promoter score (NPS), a reliable content source, a user-centric system, and the provision of validated Generative Artificial Intelligence answers on demand.

Another objective of the present invention is to enhance sales efficiency by integrating the system with sales force automation (SFA).

Additionally, the present invention aims to establish an internal guidance system.

### SUMMARY OF THE INVENTION

It will be understood that this disclosure is not limited to the particular systems, and methodologies described, as there can be multiple possible embodiments of the present disclosure which are not expressly illustrated in the present disclosure. It is also to be understood that the terminology used in the description is to describe the particular versions or embodiments only, and is not intended to limit the scope of the present disclosure.

Described herein is an AI-based system and method for training and education of, for example, healthcare professionals. In an embodiment, the system comprises multiple user devices configured to receive inputs from one or more users. A server configured to receive the user inputs via a user interface over a communication network and fetch information from one or more databases, for example, medical research databases concerning the training and education of healthcare professionals. The server comprises a memory and a processor configured to execute instructions stored in the memory. Further, a query processing and scripting module is configured to process a user query received as user input and generate a draft script based on information fetched from one or more databases using artificial intelligence and storing the same. A compliance check module is configured to verify the draft script based on one or more predefined rules stored in the server and generate structured data from a compliance-checked script. An audio/video search engine is configured to generate a plurality of audio and/or video content based on structured data using artificial intelligence. A review module is configured to receive the generated audio/video content to determine its relevancy based on predetermined parameters, wherein the review module creates a list of nuggets of description from the compliance-checked script and nuggets of audio/video content based on relevant content and filters irrelevant content and linking the description nuggets with corresponding audio/video content nuggets based on a match factor. An output module displays the linked content on a user device.

Another embodiment of the present invention discloses that the relevance of audio/video content is determined by predetermined parameters, such as an affinity score, where the output is then ranked based on the opinions/comments/transcription/published journals of renowned individuals/scientists/practitioners.

Yet another embodiment of the present invention discloses that the system learns about users through assessments and selects users' rank based on their proficiency levels, which categorizes users as beginners, practitioners, or experts by content, or experience, thereby establishing their existence within the system.

Another embodiment of the present invention discloses that the compliance check module is further configured to perform scrutiny and verifying of the audio/video content for regulatory adherence.

A preferred embodiment of the present invention discloses that the review module facilitates review and retakes functionalities to enable iterative improvements of the audio/video content and the compliance-checked script to provide nuggets of relevant content.

Yet another embodiment of the present invention discloses wherein the review module is further configured to process the relevant content for partial retakes and selectively modify sections of relevant audio/video information based on at least one stakeholder input.

Another embodiment of the present invention discloses that wherein the users encompass healthcare professionals (HCPs), medical sales representatives (MRs), medical science liaisons, and others, more specifically, healthcare professionals (HCPs) consisting of doctors, pharmacists, and caregivers, as well as representatives from various medical institutions.

A preferred embodiment of the invention discloses that wherein the predetermined parameters include behavioral traits comprising perceptions, actions, choices in prescriptions, preferences in prescriptions, views on a brand or molecule, characteristics, inclinations, medication adherence, and compliance.

One embodiment of the present invention discloses that the server is additionally configured to set up to both store and access a wide array of data, encompassing information, media content, survey inquiries including Pre-survey and Post-survey, references, medical journals, marketing, and medical communication materials, as well as training and educational content, where the data is sourced from diverse sources pertinent to the underlying products and services.

In a preferred embodiment of the present invention, the computer-implemented system discloses that the communication network pertains to either a wired or wireless system utilized for data transmission.

In a preferred embodiment of the present invention, the review module is further configured to link the nuggets and relevant portions of the compliance-checked script.

Another embodiment of the present invention discloses that the draft scripts can be edited by the user to provide personalized feedback.

Another embodiment of the present invention discloses that the user query is processed by at least two generative AI processing techniques to produce at least two draft scripts, wherein the system conducts a comparison of the generated scripts based on one or more pre-stored parameters including user perception and persona, knowledge criteria, accuracy, relevancy, comprehensiveness, clarity and context, and concurrent updated of the scripts.

In a preferred embodiment of the present invention, it is disclosed that a non-transitory computer-readable medium stores instructions. These instructions, when executed by one or more processors of a computing system, cause the system to perform a method. Inputs are received from one or more user devices. A user query is processed as user input, generating a draft script from information retrieved from one or more databases, using artificial intelligence, and storing the resultant data. Subsequently, the draft script undergoes verification based on predefined rules/parameters stored in a server. Structured data is then generated from the compliance-checked script. A plurality of audio/video content pieces is generated based on the structured data retrieved using artificial intelligence. The relevancy of the generated audio/video content is determined using predetermined parameters. This involves creating a list of nuggets of description from the compliance-checked script and nuggets of audio/video content while filtering out irrelevant content. The description nuggets are linked with corresponding audio/video content based on a match factor. The linked content is displayed on a user device.

In another preferred embodiment of the present invention, the non-transitory computer-readable medium discloses a method that involves receiving the search query by one or more processors from a digital assistant application executing on a remote client device.

In yet another embodiment of the invention, the non-transitory computer-readable medium discloses that the structured data is generated, encompassing the creation of multi-category taxonomy data based on scientific or clinical documents, diagnoses, procedures, and drug names, including multiple categories of metadata.

Furthermore, in this embodiment of the present invention, user-induced feedback on a nugget leads to a revision of the remaining nuggets within a given list of nuggets.

A preferred embodiment of the invention discloses a computer-implemented method that facilitates personalized content creation and compliance for training and education. Various inputs from one or more user devices are received as queries. At least one user query is processed and a draft script is generated based on the information fetched from one or more databases in response to the query using artificial intelligence. The draft script is then verified based on one or more predefined rules stored in the server and structured data is generated from a compliance-checked script. A plurality of audio/video content is generated based on the structured data fetched using artificial intelligence. Relevancy of the generated audio/video content is determined based on predetermined parameters, and A review module is configured to receive the generated audio/video content to determine its relevancy based on predetermined parameters, wherein a list of nuggets of description from the compliance-checked script and nuggets of audio/video content based on relevant content is generated and irrelevant content is filtered. The description nuggets are linked with corresponding audio/video content nuggets based on a match factor. An output module displays the linked content on a user device.

One embodiment of the present invention discloses that the computer-implemented method, wherein the determining comprises review and retake functionalities enabling iterative improvements of audio/video and the compliance-checked script to provide the nuggets.

In a preferred embodiment of the present invention, the computer-implemented system discloses that wherein the relevant content is further processed for partial retakes and selectively modified sections of relevant audio/video information based on stakeholder inputs.

Various objects, features, aspects, and advantages of the inventive subject matter will become more apparent from the following detailed description of preferred embodiments, along with the accompanying drawing figures in which the same numerals represent like components.

### BRIEF DESCRIPTION OF THE DRAWINGS

Non-limiting examples of the present disclosure will be described in the following disclosure with reference to the appended drawings, in which:

FIG. 1 illustrates a block diagram of a computer-implemented system for training and education, according to an embodiment of the present invention;

FIG. 2 illustrates a detailed block diagram of a server comprising different modules in a computer-implemented system, according to an embodiment of the present invention;

FIG. 3 illustrates a flow diagram of a method to facilitate content creation and compliance for training and education, according to an embodiment of the present invention; and

FIG. 4 illustrates a conditional selection flow chart of a method to facilitate content creation and compliance for training and education, according to an embodiment of the present invention.

### DETAILED DESCRIPTION OF THE DRAWINGS

Some embodiments of this invention, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present invention, the preferred, systems and methods are now described.

Insufficient and sub-optimal training, in particular for pharmaceutical representatives and liaisons, results in reduced sales, damaged reputation, legal problems, penalties, and loss of credibility. The lack of relevant content and personalization in market professionals' training further translates into a disconnect with the industry professionals such as healthcare professionals, which results in sub-optimal use of the end products impacting the revenue.

The present invention discloses an innovative platform that addresses the significant challenges faced by marketing sectors, such as pharma and medical device companies and wholesalers. The platform addresses issues specifically related to skill mismatch of the market professionals with the industry needs, periodic personalized carte blanche competency training, high burnout/high attrition rates, inefficiencies/excessive costs/redundancies.

The platform curates content, leverages feedback, makes data-driven recommendations to personalize engagement of market professionals, such as medical representatives (MRs) and the like, with industry professionals, such as healthcare professionals (HCPs), and promotes an improved continuous learning journey based on AI and user-specific interventions.

The methodology elevates the role of MRs and Marketing Specialists leading to enhanced opportunities and higher quality of care through ongoing education and skill-building, leading to improved patient outcomes.

The system and method as disclosed help deliver rapid skilling content, summarized with quick concurrent, updated research in easily digestible chunks, supported with GenAI, which simulates Question and Answer (Q&A) sessions with industry professionals. It empowers especially HCPs with at-the-point-of-care assistance and access to complex real-world cases and knowledge leaders' insights for accelerated product awareness and informed decisions.

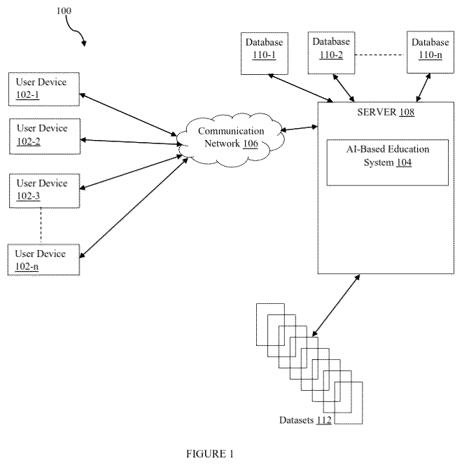

FIG. 1 illustrates a network diagram 100 for implementing an AI-based system 104 (hereinafter, the system 104) for the training and education of professionals such as healthcare market professionals. As shown, multiple user devices 102-1, 102-2, . . . , 102n (collectively referred to as 102) may be available to communicate with a server 108 over a network 106, wherein the server 108 may host the system 104. In another embodiment, the user devices 102 may be executing a digital assistant application (not shown), which can be a computer-based software application or a web application. For example, the digital assistant application can be integrated within a customer relationship management (CRM) application or an electronic medical record (EMR) application, such as a flashcard, or as a standalone web application. The digital assistant application can communicate with, or form a portion of, the system 104. For example, the user devices 102 may be used by a physician 102-1, a marketing professional 102-2, a patient 102-3, and the like who would like to get training material on a given topic or health condition to receive data from, or send data to, the server 108. This distribution of the server 108 amongst the various stakeholders may be provided, for example, by way of a distributed computing network having several devices under the control of the ecosystem members, and running all or a portion of the system 104 while interconnected by the network 106. The stakeholder inputs may encompass public content and comments, such as endorsements or public feedback provided by the company, HCPs, or Industry Experts. Accordingly, the solution can be integrated at a point of care, in a pharmaceutical company CRM system, or other locations.

The server 108 may be a remote server or a cloud server and is configured to access a plurality of databases 110 to fetch industry-specific updates and information in real time. The communication network 106 pertains to either a wired or wireless system utilized for data transmission. The network 106 facilitates seamless communication and data exchange between the users 102 and the server 108. The server 108 is adapted to store training dataset 112 which helps the system 104 to learn automatically using machine learning.

The system 104 is configured to handle and analyze user queries received as inputs and ensures efficient interaction and information flow. The user query undergoes processing via System 104, employing at least two artificial intelligence techniques, for example, ChatGPT, Gemini, and the like, to produce at least two draft scripts. In a preferred embodiment, the system 104 conducts a comparison of the generated scripts based on predefined rules/parameters configured to present a personalized and most suitable draft script from the user's query including but not limited to the user perception and persona as gauged by the system 104 from the previous interactions with the user, the knowledge criteria, content relevancy, comprehensiveness, clarity and context, and concurrent, updated of the information.

The system 104 processes the query to provide one or more draft scripts and then runs a compliance mechanism through which the draft script is converted into a compliance-checked script. In an embodiment, the drafts can be edited by a privileged user, for example, a content creation user, 102-2, manually to add personalization, both before and after the publishing of the content. In operation, in a preferred embodiment, the system 104, based on the behavior perceptions, persona of the user/targeted audience, and knowledge criteria of a user as learned from the interaction of the user 102 with the system 104, provides a draft script. Subsequently, a compliance mechanism is employed to convert the draft script into a compliance-checked script based on pre-defined and pre-stored parameters such as relevance, accuracy, comprehensiveness, clarity, and concurrent updatedness of the content by industry experts as content endorsements. During a compliance check, historical data undergoes comparison with the recent most information in the sector, facilitating the incorporation of concurrent updates to the content. This process ensures alignment by leveraging records to enhance the accuracy and integrity of the content, which is vital for effective decision-making for healthcare professionals. In an embodiment, a time stamp is assigned to the script, be it a draft script or a compliance-checked script or in the final content, generated by the system, both before publishing or after publishing of the content for end usage for training and education purpose. The time stamp is saved in the system 104 for comparison of the content at some future date with scripts generated at that future date to check the updatedness of the content. Further, human sources of information may also be added in providing compliance-checked script(s). This may include information from, for example in the case of healthcare industry, healthcare professionals, doctors, content taken from medical transcriptions and the like where anonymization for example transcribed data from opted in doctors for usability for accelerated learning, is used by the system for future reference as intelligence of learning and content creation.

In an embodiment, the content may be approved by at least one HCP or expert in the field, who may have been assigned a weightage in terms of knowledge, experience, expertise, affinity, and related parameters. From the compliant script, the system 104 generates structured data, which is subsequently used to generate audio/video content using another AI audio/video generating engine. In an embodiment, generating the structured data includes generating multi-category taxonomy data based on for example, scientific or clinical documents, diagnosis, procedures, and drug name and include multiple categories of metadata.

The audio/video content generated based on such structured data is again checked for compliance in terms of, for example, relevancy, validity, and legal guidelines, and filtered based on a set of predefined rules, for example, content difference, suitability, and durations, to provide a list of relevant nuggets of audio/video content. The resulting audio/video content is then distributed into subtitles onto the scenes of the audio/video linked within relevant nuggets of the description by compiling the audio/video content sequenced with that of the content of the compliance-checked script, as a match factor. The same is then provided as output to the user as piecemeal content with a description to maximize user engagement with the study material.

In operation, a user 102 requires enrollment with the system 104 by providing basic information as well as information relating to his/her educational/professional background and expertise, if any for an educational or training journey. Based on the information received during the enrollment and also the specific preferences/requirements of the user 102, various course preferences and recommendations are offered to the user. These preferences and recommendations may include, for example, a specific domain, level of the course, duration of the course, weekly time one can dedicate, and the like. Given the complexity of the course opted by the user and the time duration, the system 104 may tailor a personalized course for the user. In an embodiment, the system 104 may assess a behavioral pattern of the user to prepare the course material. In an embodiment, the system 104 based on the initial information provided by the user pertaining to a course, provides a specific number of options or mandatory and/or periodic courses from which the user may select the most relevant topic of interest or need of the user at that time. The system 104 based on the selection and other information provided by the user 102, such as course duration, and the learning acquired by the system 104 of the user 102, provides information nuggets that are most suited for the user in terms of maximizing indulgence of the user 102 with the course. These information nuggets, which are part of the draft script, may be checked for compliance, i.e., relevancy, accuracy, comprehensiveness, and dated information, and provide a compliant script presented as nuggets of information suited for the user. These nuggets are divided to attract the maximum attention of the user. In an embodiment, the system 104 allows the user or a user looking at the compliance of the draft script to provide feedback on a nugget which would lead to corresponding revision in the list of nuggets or subsequent nuggets generated following the feedback.

In an embodiment, the system 104 allows the user to personalize the nuggets according to their skill level, with contextual information flowing to interconnected nuggets. The system 104 adapts to a user's personalization choices, offering an average number of nuggets for the course selected.

In an embodiment, the system 104 is configured to curate content that has a high-affinity score, a higher net promoter score, is reliable and clickable, and user-centric, and makes available validated Generative AI answers on demand. It involves calculating affinity scores for different attributes, considering recent interactions and preferences more significantly by giving weightage to real-time activities and high-intent engagement. Initially, individual-level affinity scores are defined for each participant's “neighborhood” based on specific variable measures. Following this, diagnostic verification and classification algorithms utilize these multivariate affinity score profiles. Affinity-based classification involves dividing data into training and test samples, conducting cross-validation on the training data, and comparing it to weighted K-nearest neighbors (KNN) classification.

This implementation of affinity score calculation has several purposes, such as aiding in treating various patients based on in-depth insights into their disease symptoms and enhancing sales by educating or training them. It may also involve Health Care Providers (HCPs) incorporating data from individuals with chronic and treatment-resistant conditions, alongside healthy controls. Individualized affinity scores facilitate the target individual training or education based on the creation of relevant content, generating audio or video ‘nuggets’. These nuggets cater to existing influencers between the provider and trainee, forming a vital link in the learning process. For instance, there might be four influencers identified between the provider and trainee. Additionally, influencers themselves gain insights into courses through trainees, establishing a chain of learning that passes from one individual to another. Achieving high accuracy in training, nested cross-validation, and prediction steps, affinity score-based classification surpasses KNN classification in both training and test datasets.

Specifically, “affinity scores” capture patterns for treatment responsiveness, resistance, or sales improvements, indicating an individual's affinity to multiple diagnostic groups across various variables. This individualized approach supports clinicians in acknowledging comorbidity, severity, disability, and prognosis, and tailoring intervention strategies accordingly. The present invention integrates affinity scores into diagnostic verification, classification, and prediction algorithms, serving as a clinical decision support system to establish diagnoses and predict prognosis. Finally, k-means clustering is used to assess the separability of treatment-resistant individuals from healthy controls and those with chronic diseases based on multivariate Affinity Score profiles.

The present invention provides an on-demand personalized rapid re-skilling solution via a training and education platform. The system facilitates a Rapid Learning Curve within the healthcare sector by providing expedited skilling content that condenses up-to-date research into easily digestible chunks. Supported by generative artificial intelligence, it conducts simulated question-and-answer sessions with healthcare professionals (HCPs). This approach ensures swift comprehension and retention of information, contributing to the acceleration of the learning curve.

Additionally, the system incorporates a Just-In-Time Customer Centricity feature, specifically tailored for healthcare and other educating applications, enabling the rapid delivery of in-the-moment preparatory content for Medical Sales Representatives (MSRs) before they meet Healthcare Professionals (HCPs). The content is condensed into essential bite-sized portions, enhancing HCP engagement and boosting satisfaction levels with more reliable and accurate information.

The system streamlines content creation with AI-generated visual courses, taking just minutes from the final approved script. It simplifies narration, and background music, and highlights subtitles efficiently. AI assistance availability saves valuable time and costs for content writers, content creators, and agencies. Rapid generation of skilling content offers numerous features and benefits within the healthcare domain. It streamlines content creation by utilizing AI-generated visual courses, requiring only minutes from the final approved script. The system simplifies the selection of narrators and background music while allowing content creators to efficiently highlight subtitles. The availability of AI assistance saves valuable time and costs for Medical Writers, Content Creators, and Agencies.

Another noteworthy feature facilitated by the present system is peer connectivity, particularly within the healthcare domain. The peer connectivity establishes connections among company peer MSRs/Medical Science Liaisons and a ‘Friendly’ (Healthcare professionals) HCPs panel, providing expert-endorsed on-demand reliable domain knowledge. It brings forth Key Opinion Leader (KOL) insights, fostering a better understanding of customers.

The system facilitates the healthcare institution's peer-to-peer support for Healthcare Professionals (HCPs), empowering them with at-the-point-of-care assistance and access to complex real-world cases and Key Opinion Leader (KOL) insights. This initiative aims to accelerate drug awareness and enable informed decisions among HCPs.

The system offers Pre-Surveys to customize courses based on learners' skill levels, optimizing their learning by skipping irrelevant content. The performance of MSR/MSLs is monitored through polls, quizzes, and badges to ensure active engagement. AI/ML algorithms determine the ranking of doctors, nurses, MSR/MSLs based on quiz results, categorizing them as beginners or experts and providing individual certifications accordingly. Utilizing pre-surveys to tailor content nuggets helps personalize the learning experience, significantly reducing the necessary training time.

Through healthcare's engage feature, stimulating Polls and Post-Surveys create a sense of community and relevance in the content, consequently boosting learner satisfaction. Empowering MSRs/MSLs to address skill gaps and improve patient outcomes, healthcare utilizes generative artificial intelligence-powered learning. Specifically, the use of post-surveys serves the purpose of certification and enables additional personalization. Employing other personal data for further personalization to achieve better outcomes.

The healthcare domain undergoes a transformation in content creation with AI-driven courses, ultimately saving time for creators. Tailoring content based on Pre-Surveys and incorporating engaging polls and quizzes enhances the learning experience for MSR/MSLs, fostering a sense of community and satisfaction. Generative AI-powered education further empowers MSRs/MSLs, enhancing their skills and ultimately improving patient outcomes.

The present invention offers Just-in-Time Customer Centricity and Real-Time Insights for Informed Engagement. This feature empowers Medical Sales Representatives (MSRs) to rely on current Healthcare Professional (HCP) information for effective interactions. Within the healthcare domain, the system aggregates up-to-date research from sources such as Pubmed, Umin, and social networking services (SNS), delivering concise script summaries. MSRs can read these summaries, voice them aloud, or present them as brief visual videos using our Content Creator AI. This ensures that MSRs engage at the appropriate level with precision.

Smart HCP Tracking and Updates within the healthcare institution actively monitor various aspects of Healthcare Professionals' engagements, including their public attendance records, speaker engagements, event visitations, interest updates, and evolving colleague relationships as the shifting trends in persona and community segments. This informative content is utilized to provide Medical Sales Representatives (MSRs) with real-time updates, ensuring their interactions are timely and well-informed.

Enhanced conversations in the healthcare domain which offers essential guidance by providing key questions that MSRs/MSLs should ask during their interactions with HCPs. This guidance includes simulations of question-and-answer sessions with anticipated or predictive responses, enhancing their preparedness and fostering more engaging interactions.

Healthcare revolutionizes HCP engagement, leading to more informed and effective conversations, thereby accelerating market penetration and advancing healthcare outcomes to unprecedented levels. Through the transformation of content creation with AI, it saves time and costs for creators. Generative AI-powered education further empowers MSRs/MSLs, enhancing their skills and improving patient outcomes.

The system facilitates peer connectivity, offering several features and benefits such as community access, medical knowledge access, HCP engagement, and ensuring training compliance. Within the healthcare domain, it can connect novice MSRs/MSLs with experienced peers, fostering knowledge sharing and skill support within the community.

Moreover, the healthcare organization links experienced peers with a group of ‘Friendly HCPs’, enabling knowledge sharing and skill support. This platform allows practitioners and expert-level MSRs/MSLs to connect with HCPs, facilitating access to the company's ‘Friendly HCPs Group’ for timely expertise sharing in drug diagnosis, prescription, treatment, assessment, and care, thereby accelerating conversions. For example, there could be a service provider-friendly HCP group that may include registered professionals from the industry as potential endorsers of content before it is published and/or a client HCP-friendly group including registered professionals on the client's panel.

Furthermore, within the healthcare domain, the system 104 monitors new millennial, mid-career, and senior professionals by individual content: beginner level, practitioner level, and expert level where content varies depending on the target audience including doctors, nurses, MSR/MSL participants, and the like professionals in the healthcare industry providing valuable competency data, progress, and feedback to the individuals, managers, executives and human resources (HR). This revolutionary approach in the healthcare domain facilitates bilateral engagement with HCPs, addressing skills gaps, reducing costs, and eliminating inefficiencies. This dynamic learning environment creates personalized experiences, ultimately leading to improved patient outcomes and elevated healthcare standards.

Further, the present invention offers peer-to-peer point-of-care HCP access, encompassing various features and benefits such as HCP network, MR/MS/MSL assistance, MSL collaboration, community boards, and content transcription, which can become tomorrow's knowledge for futuristic professionals. The system 104 provides HCPs with access to their peers, facilitating advanced searches for required support at the point of care. Within the healthcare platform, connected HCPs can support other HCPs during calls through the involvement of the MSLs. Moreover, in an embodiment, the system 104 empowers MSLs to engage other experienced HCPs during calls, ensuring timely expertise and accelerated retrieval of Real-World data. Through Generative AI, the conversations can be further enhanced to bring out better decision-making and patient outcomes.

The implementation of the system 104 involves individual evaluation of the users based on historical assessment data and comprehension confirmation tests to assess the outcome of their learning. The system expansion incorporates personnel evaluations beyond individual assessments, culminating in a comprehensive personnel evaluation system. Detailed data on users, for example, doctors is obtained through the present learning system 104, also subsequently linkable with pharmaceutical companies' sales activities.

The system (100) allows doctors, medical representatives, pharmacists, and users to log in by registering through the authorized application on their user devices. Specifically, signed-up/registered doctors and users have access to information. A registered user (102) can engage with an expert in their field, such as a medical representative or another professional chosen by the user. This interaction facilitates precise and detailed knowledge regarding, for example, up-to-date diagnostic, treatment, curative medicines, adherence, and medical devices, thereby enabling the personalization of information for the user's needs in a broad spectrum.

The system and method as disclosed promote discussions on complex patient cases through meetings and webinars, offering valuable insights, polls, and survey data to expedite drug awareness and gather market intelligence from leading key opinion leaders (KOLs). Additionally, it automatically transcribes and anonymizes communications while gathering real-world case studies for supportive information and insights from KOLs, essential for pharmaceutical intelligence reports. This facilitates faster and more in-depth drug awareness, enabling well-informed decision-making. The system's comprehensive features collectively address skills gaps, reduce costs, and eliminate inefficiencies.

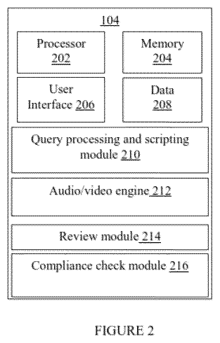

In FIG. 2, a block diagram of the system 104 is depicted in an exemplary embodiment. The system 104 as shown includes one or more processors 202, memory 204, at least one user interface 206, data 208, a query processing and scripting module 210, an audio/video engine 212, a review module 214, and a compliance check module 216.

In an embodiment, the system 104 receives a user query from a user via at least one user device, say 102-1, over the network 106. The user query is received at the server 108 hosting the system 104. The query processing and scripting module 210 based on the user query generates a draft script by fetching information from one or more knowledge databases, say 110-1, using artificial intelligence. In an embodiment, the query processing and scripting module 210 first pre-processes the user query, for example, using natural language techniques, before using the query to fetch information from the one or more databases 110.

Further, the compliance check module 216 is configured to verify the draft script and provide a compliant script for the query. The draft script may contain part structured data, unstructured data such as real-world data scientific document data, and expert knowledge data in a given sector. The compliance check module 216 may generate structured data or metadata such as expert-defined rules based on expert knowledge data and the unstructured data generated by one or more AI engines and store the same as part of data 208.

The structured data can include layers of information, which may be specific to a particular disease or a drug. In an embodiment, the real-world data is processed and transformed into a common format for machine learning. The real-world data, the scientific document data, and expert opinion data can be processed by machine learning classifiers to generate taxonomical metadata. For example, the unstructured data can be tagged by machine learning classifiers with medical-specific topics. In an embodiment, the data is mined to generate multi-category taxonomy data with associated metadata.

The verification process is based on one or more rules and/or parameters already stored for example as part of data 208 or can be generated from the unstructured data. In an embodiment, the compliance check module 216 takes into account different draft scripts generated using one or more AI algorithms on related topics in response to different yet related user queries on a given topic and based on the predefined rules generates a compliance-checked script. The module 216 may access databases of participating users such as healthcare providers, and market professionals, and the rules associated with, for example, referring members to specific physicians based on the symptom or condition described, expert-defined rules, Medicaid or commercial benefit rules, an affinity score, a user level score, and the like. In an embodiment, the compliance check module 216 takes input from at least one user to complete the compliance process, thus personalizing the script for the querying user. The compliance-checked script may also take into account, for example, real-time news feeds on the topic, real-time opinions of experts being collected through interviews, surveys of professionals at different levels of engagement in the sector in different verticals, and the like.

Further, the audio/video engine 212 is configured to generate audio/video content based on structured data using artificial intelligence. In an embodiment, the audio/video engine 212 through an AI-based text video generator provides audio-video content pertinent to the structured data as received by the audio/video engine 212 from the compliance check module 216. Here as well, natural language processing and machine learning algorithms such as autoregressive transformers may be employed for generating audio/video content generation. The audio/video engine 212 may also learn from existing dataset(s) 112.

Further, the review module 214 is configured to receive the generated audio/video content and assess its relevance. Again, the rules/parameters for assessing the relevancy may be stored as part of data 208 and may be generated from the structured data. The rules/parameters established for approving content information encompass various criteria, involving assessment by nurses, doctors, the hospital panel, company doctors, medical writers, and experts. These individuals evaluate the content's relevance, accuracy, and fact-checking, leading to the sub-categorization of relevant content based on four main aspects: Relevance, Timeliness, and Comprehensiveness of audio/video content information.

The review module 214 separates relevant audio/video content from the generated content of the audio/video engine 212 and creates condensed nuggets of the audio/video content, while irrelevant content is filtered out. In an embodiment, the nuggets and relevant sections of the compliance-checked script via the review module 214.

In an embodiment, the review module 214 facilitates review and retake functionalities to enable iterative improvement of the audio/video content and the compliance-checked script to provide nuggets of relevant content. In an embodiment, the relevancy of the curated content is assessed based on parameters such as an affinity score, accuracy based on peer-reviewed publications, ranking of opinions of prominent individuals on the topic, endorsements from renowned individuals, and the like. In an embodiment, the system 104 gathers user information through evaluations, such as through online questionnaires, surveys, and the like, and assigns user rankings according to their skill levels, thereby classifying them for example as novices, professionals, or experts, to define their level for education and training purposes.

More particularly the predetermined parameters include behavioral traits comprising perceptions, actions, choices in prescriptions, preferences in prescriptions, views on a brand or molecule, characteristics, inclinations, medication adherence, and compliance.

The present disclosure further discloses that the server 108 is additionally configured to set up to store and access a wide array of data, encompassing information, media content, survey inquiries including pre and post-surveys, references, scientific journals, as well as training and educational content, where the data is sourced from diverse sources about the underlying products and services.

Finally, the linked content is displayed on the user's device 102-1 via the user interface 206. This content, refined and curated through the system's various processing stages, is presented to the user for their consumption.

The architecture of the system 104 underscores the integration of diverse modules within the server to manage user inputs, process queries, retrieve information from databases, and present refined and personalized content to the end-user. Through this intricate network of modules and functionalities, the system aims to streamline the creation, processing, and delivery of relevant content in a structured and user-friendly manner.

Enhancing user experience and efficiency, the system 104 demonstrates the synergy of multiple components working cohesively to handle information and content flow within an educational or training context, ensuring the delivery of precise and targeted materials to the end user.

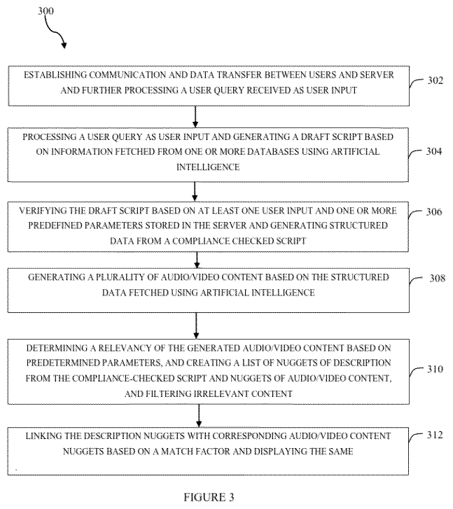

FIG. 3 presents a flow diagram outlining a method to facilitate content creation and compliance for training and education. At step 302, communication and data transfer are established between the users and the server and receiving a user query as input. At step 304, the user query is processed and a draft script is generated from the information fetched from knowledge databases using AI.

At step 306, the draft script undergoes verification using one or more predefined rules/parameters stored in the server, and generating structured data from a compliance-checked script. Additionally, the system 104 incorporates behavior learning tailored for new users to generate content information.

At step 308, multiple pieces of audio/video content are generated based on structured data obtained using artificial intelligence. At step 310, the relevance of the generated audio/video content is determined by predetermined parameters, creating condensed nuggets of relevant audio/video content and filtering out irrelevant segments. These condensed nuggets are then linked with the compliance-checked script and displayed on user devices, at step 312.

In operation, a user 102 requires enrollment with the system 104 by providing basic information as well as information relating to his/her educational/professional background and expertise, if any for an educational or training journey. Based on the information received during the enrollment and also the specific preferences/requirements of the user 102, various course preferences and recommendations are offered to the user. These preferences and recommendations may include, for example, a specific domain, level of the course, duration of the course, weekly time one can dedicate, and the like. Given the complexity of the course opted by the user and the time duration, the system 104 may tailor a personalized course for the user. In an embodiment, the system 104 may assess a behavioral pattern of the user to prepare the course material. In an embodiment, the system 104 based on the initial information provided by the user pertaining to a course, provides a specific number of options or mandatory and/or periodic courses from which the user may select the most relevant topic of interest or need of the user at that time. The system 104 based on the selection and other information provided by the user 102, such as course duration, and the learning acquired by the system 104 of the user 102, provides information nuggets that are most suited for the user in terms of maximizing indulgence of the user 102 with the course. These information nuggets, which are part of the draft script, may be checked for compliance, i.e., relevancy, accuracy, comprehensiveness, and dated information, and provide a compliant script presented as nuggets of information suited for the user. These nuggets are divided to attract the maximum attention of the user. In an embodiment, the system 104 allows the user or a user looking at the compliance of the draft script to provide feedback on a nugget which would lead to corresponding revision in the list of nuggets or subsequent nuggets generated following the feedback.

In an embodiment, the system 104 allows the user to personalize the nuggets according to their skill level, with contextual information flowing to interconnected nuggets. The system 104 adapts to a user's personalization choices, offering an average number of nuggets for the course selected.

The method also includes functionalities for review and retake, enabling iterative improvements to both the audio/video content and the structured information, refining and presenting nuggets of relevant content. Ultimately, the refined and pertinent content is displayed on the user's device. The user's knowledge growth and content curation are aligned with their evolving proficiency. Monitoring the user across social media, publications, journals, and data collection aids in comprehending changing requirements. Subsequently, the engine generates refined content and recommendations accordingly. External factors may receive a specific weight, while behavioral patterns typically carry an 80% weighting.

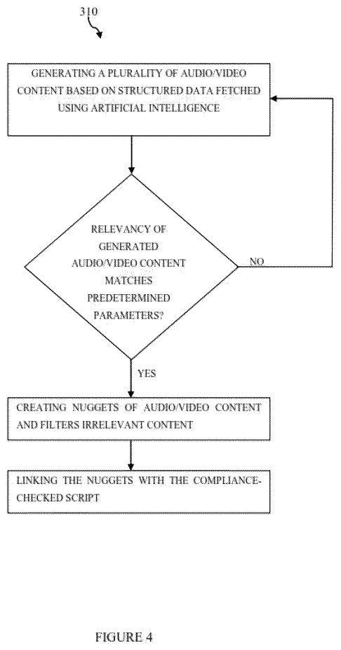

The method's sequential steps emphasize the systematic approach to content creation and refinement, leveraging various stages of processing to ensure the delivery of high-quality and relevant audio/video content, as shown in FIG. 4. The iterative nature of the process, with review and retake functionalities, highlights a continuous improvement loop aimed at enhancing the quality and relevance of the delivered content for optimal user experience in educational or training settings.

FIG. 4 represents a conditional selection flow chart of the content creation and compliance for training and education. Initially, data transfer and communication occur between the users and the server. Subsequently, a user query is processed as input. A draft script is generated using information fetched from one or more databases using artificial intelligence based on the input query.

The relevancy of the generated audio/video content is checked against predetermined parameters. If the content matches, nuggets of relevant audio/video content are created, filtering out irrelevant segments. If not, the process loops to fetch information from different databases using artificial intelligence until a draft script is generated. Upon creating the nuggets linked with the compliance-checked script, the final output is displayed on the user's device.

Embodiments of the present invention may be provided as a computer program product, which may include a computer-readable medium tangibly embodying thereon instructions, which may be used to program a computer (or other electronic devices) to perform a process. The computer-readable medium may include but is not limited to, fixed (hard) drives, magnetic tape, floppy diskettes, optical disks, compact disc read-only memories (CD-ROMs), magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the computer-readable medium or by copying the code from the computer-readable medium into another computer-readable medium (e.g., a hard disk, RAM, etc.) or by transmitting the code on a network for remote execution. Various methods described herein may be practiced by combining one or more computer-readable media containing the code according to the present invention with appropriate standard computer hardware to execute the code contained therein. An apparatus for practicing various embodiments of the present invention may involve one or more computers (or one or more processors within a single computer, or one or more processor cores) and storage systems containing or having network access to computer program(s) coded following various methods described herein, and the method steps of the invention could be accomplished by modules, routines, subroutines, or subparts of a computer program product.

While for purposes of simplicity of explanation, the illustrated methodologies are shown and described as a series of blocks/steps, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and the illustrative examples shown and described. Thus, this application is intended to embrace alterations, modifications, and variations that fall within the scope of the appended claims.

The methodology and techniques described for the exemplary embodiments can be performed using a machine or other computing device within which a set of instructions when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client-user machine in a server-client-user network environment, or as a peer machine in a peer-to-peer (or distributed) network environment.

Moreover, although the present invention and its advantages have been described in detail, it should be understood that various changes, substitutions, and alterations can be made herein without departing from the invention as defined by the appended claims. Moreover, the scope of the present application is not intended to be limited to the particular embodiments of the process, machine, manufacture, and composition of matter, means, methods, and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

The preceding description has been presented with reference to various embodiments. Persons skilled in the art and technology to which this application pertains will appreciate that alterations and changes in the described structures and methods of operation can be practiced without meaningfully departing from the principle, spirit, and scope.

We claim:

1. A computer-implemented system (100) for training and education, the system (100) comprising:
one or more user devices (102-1, 102-2, . . . 102-n) configured to receive inputs from one or more users;
a server (108) configured to receive the user inputs over a communication network (106) and fetch information from one or more databases (110), wherein the server (108) comprises:
a memory (204);
a processor (202) configured to execute instructions stored in the memory (204),
a query processing and scripting module (210) configured to process a user query received, via a user interface, as a user input and generate a draft script from information fetched from the one or more databases (110) using artificial intelligence and storing the same;
a compliance check module (216) configured to verify the draft script based on one or more predefined parameters stored in the server (108) and generate structured data from a compliance-checked script;
an audio/video search engine (212) configured to generate a plurality of audio/video content based on the structured data using artificial intelligence;
a review module (214) configured to receive the generated audio/video content to determine its relevancy based on predetermined parameters, wherein the review module (214) creates a list of nuggets of description from the compliance-checked script and nuggets of audio/video content based on relevant content and filters irrelevant content;
linking the description nuggets with corresponding audio/video content nuggets based on a match factor; and
an output module to display the linked content on a user device.

2. The system (100) as claimed in claim 1, wherein the relevance of audio/video content is determined by predetermined parameters, such as an affinity score, where the output is then ranked based on the opinions of renowned individuals.

3. The system (100) as claimed in claim 1, wherein the system (100) learns about users through assessments and selects users' rank based on their proficiency levels, which categorize users as beginners, practitioners, or experienced individuals, thereby establishing their existence within the system (100).

4. The system (100) as claimed in claim 1, wherein the compliance check module (216) is further configured to perform scrutiny and verifying of the audio/video content for regulatory adherence.

5. The system (100) as claimed in claim 1, wherein the review module (214) facilitates review and retake functionalities to enable iterative improvements of the audio/video content and the compliance-checked script to provide nuggets of relevant content.

6. The system (100) as claimed in claim 1, wherein the review module (214) is further configured to process the relevant content for partial retakes and selectively modify sections of relevant audio/video information based on at least one stakeholder inputs.

7. The system (100) as claimed in claim 1, wherein the users encompass healthcare professionals (HCPs), medical representatives (MRs), sales representatives, and more specifically, healthcare professionals (HCPs) consist of doctors, pharmacists, caregivers, as well as representatives from various medical institutions.

8. The system (100) as claimed in claim 1, wherein the predetermined parameters include behavioral traits comprising perceptions, actions, choices in prescriptions, preferences in prescriptions, views on a brand or molecule, characteristics, inclinations, medication adherence, and compliance.

9. The system (100) as claimed in claim 1, wherein the server (108) is additionally configured to set up to both store and access a wide array of data, encompassing information, media content, survey inquiries including Pre-survey and Post-survey, references, medical journals, marketing, and medical communication materials, as well as training and educational content, where the data is sourced from diverse sources.

10. The system (100) as claimed in claim 1, wherein the review module (214) is further configured to link the nuggets and relevant portions of the compliance-checked script.

11. The system (100) as claimed in claim 1, wherein the draft scripts are edited by the user (102) to provide personalized feedback.

12. The system (100) as claimed in claim 1, wherein the user query is processed by at least two generative AI processing techniques to produce at least two draft scripts, wherein the system 104 conducts a comparison of the generated scripts based on one or more of pre-stored parameters including user perception and persona, knowledge criteria, accuracy, relevancy, comprehensiveness, clarity and context, and concurrent updatedness of the scripts.

13. A computer-implemented method to facilitate content creation and compliance for training and education, the method comprising the following steps:
receiving inputs from one or more user devices (102-1, 102-2, . . . 102-n);
processing a user query as user input and generating a draft script from information fetched from one or more databases (110) using artificial intelligence and storing the same;
verifying the draft script based on one or more predefined rules/parameters stored in a server and generating structured data from a compliance-checked script;
generating a plurality of audio/video content based on the structured data fetched using artificial intelligence;
determining a relevancy of the generated audio/video content based on predetermined parameters, and creating a list of nuggets of description from the compliance-checked script and nuggets of audio/video content, and filtering irrelevant content;
linking the description nuggets with corresponding audio/video content nuggets based on a match factor; and
displaying the linked content on a user device.

14. The method as claimed in claim 13, wherein the determining comprises review and retake functionalities enabling iterative improvements of audio/video and the compliance-checked script to provide the nuggets.

15. The method as claimed in claim 13, wherein the relevant content is further processed for partial retakes and selectively modifying sections of relevant audio/video information based on at least one stakeholder inputs.

16. A non-transitory computer-readable medium storing instructions, which when executed by one or more processors of a computing system, cause the computing system to perform a method comprising:
receiving inputs from one or more user devices (102-1, 102-2, . . . 102-n);
processing a user query as user input and generating a draft script from information fetched from one or more databases (110) using artificial intelligence and storing the same;
verifying the draft script based on one or more predefined rules/parameters stored in a server (108) and generating structured data from a compliance-checked script;
generating a plurality of audio/video content based on the structured data fetched using artificial intelligence;
determining a relevancy of the generated audio/video content based on predetermined parameters, creating a list of nuggets of description from the compliance-checked script and nuggets of audio/video content, and filtering irrelevant content;
linking the description nuggets with corresponding audio/video content based on a match factor; and
displaying the linked content on a user device.

17. The non-transitory computer-readable medium of claim 16, wherein the method includes receiving, by the one or more processors, the search query from a digital assistant application executing on a remote client device.

18. The non-transitory computer-readable medium of claim 16, wherein generating the structured data includes generating multi-category taxonomy data based on scientific or clinical documents, diagnosis, procedures, and drug name and include multiple categories of metadata.

19. The method as claimed in claim 13, wherein a user induced feedback on a nugget leads to a revision of the rest of the nuggets in a given list of nuggets.

20. The method as claimed in claim 13, wherein the verifying includes assigning a time stamp to the linked content.

21. A method and system for delivering personalized multimedia content to target recipients via preferred communication channels, comprising: identifying recipient preferences and contextual data, generating or selecting disease-specific or drug-specific video or audio content, and transmitting the multimedia content through email, SMS, or other preferred communication platforms, wherein the recipient can asynchronously access the content, including scenarios such as patients receiving educational videos tailored to their disease or doctors receiving new drug information requested or questions responded and updates in an audio format while commuting.
